(19) United States
(12) Patent Application Publication
(10) Pub. No.: US 2007/0098274 A1
(43) Pub. Date: May 3, 2007

(54) System and method for processing compressed video data

(75) Inventors: Mohamed M. Ibrahim, Kayalpatnam (IN); Supriya Rao, Bangalore (IN)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/261,359

(22) Filed: Oct. 28, 2005

(51) Int. Cl. G06K 9/36

(52) U.S. Cl. 382/233

(57) ABSTRACT

A system and method processes compressed video data. Motion vectors are extracted from the compressed video data, and minimum bounded regions of a moving object are identified. An inverse discrete cosine transform is applied to the minimum bounded region, and background information is subtracted out from the moving object.

### TECHNICAL FIELD

The present invention relates to the field of video processing, and in particular, but not by way of limitation, the processing of compressed video data.

### BACKGROUND

With heightened awareness about security threats, interest in video surveillance technology and its applications has become widespread. Historically, such video surveillance has used traditional closed circuit television (CCTV). However, CCTV surveillance has recently declined in popularity because of the exponentially growing presence of video networks in the security market. Video networks, and in particular intelligent video surveillance technology, bring to the security and other industries the ability to automate an intrusion detection system, maintain the identity of the unauthorized movement during its presence on the premises, and categorize moving objects. One aspect of this, video object segmentation, is one of the most challenging tasks in video processing, and is critical for video compression standards as well as recognition, event analysis, understanding, and video manipulation.

Among all the forms of media used in surveillance and other video applications, multimedia enjoys a unique benefit in that it encompasses multiple formats such as video, audio, and text in a single stream. Because of the presence of these multiple formats, much of the multimedia content available today is in a compressed format (MPEG, JPEG etc.), and most of the new video and audio data that will be produced and distributed in the future will be in standardized, compressed format.

Since most video data is already compressed, it is more efficient to directly process that data in the compressed domain rather than decompressing the data into the spatial domain. Moreover, the block based nature of compressed domain data drastically reduces the amount of data that has to be processed, thereby adding to the efficiency of directly processing compressed video data. Compressed video contains information about spatial energy distribution within the image blocks, and frequency domain representations relay information on image characteristics such as texture and gradient. Furthermore, motion information is readily available in a compressed format without incurring the cost of estimation of the motion field. Though most of these features can be extracted from decompressed video with higher precision, it requires higher computational resources.

However, compressed domain analysis has limitations as well. The Discrete Cosine Transform (DCT) technique of compressing video data removes the spatial correlation among the pixels within a block. Thus, the precision of the segmentation degrades by the block dimension. Since the goal of motion compensation is to provide a good prediction, but not necessarily to find the correct optical flow, the motion vectors (MV) in a compressed format are often contaminated with mismatching and quantization errors. Additionally, the motion fields in MPEG streams are quite prone to quantization errors. Moreover, due to its nature of block based processing, motion detection in compressed video leads to distorted localization and measurement information. This disturbs the consistency of the geometric properties of moving objects and hence complicates subsequent modules in video surveillance systems such as Video Motion Tracking (VMT) and Video Object Classification (VOC).

Several attempts have been made to overcome these shortcomings through effective filtering of motion vectors and DCT coefficients, thereby paving the way for accurate motion segmentation. One such method proposes a region segmentation and clustering based algorithm to detect objects in MPEG compressed video. This method suffers from several shortcomings, including the inability to handle the motion vectors of multiple P-frames. Another method segments dynamic regions based on the DCT coefficient similarity and true/false motion block classification. However, this method requires tracking of individual regions.

There is therefore a need in the art of video processing for an improved system and method to process compressed video data.

### BRIEF DESCRIPTION OF THE DRAWINGS

FIG. 1 is a flowchart of an example embodiment of a process for analyzing compressed video data.

FIG. 2 is output from an example embodiment of a system that processes compressed video data.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

### Removing Noise from Motion Vectors

Motion vectors and Discrete Cosine Transform (DCT) coefficients are the two prime sources of information about a scene in compressed video data. However, both motion vectors and DCT coefficients are corrupted by noise. Additionally, both are available at different levels of granularity. That is, the motion vectors are normally available at a macro block level (e.g., 16 pixels×16 pixels), while the DCT coefficients are normally available at a block level (e.g., 8 pixels×8 pixels). These issues pose a concern in any system and method that processes compressed video data. Therefore, in an embodiment, a method and system removes the noise from these two sources of information, and then combines the noise-less motion vectors and DCT coefficients to get a robust estimate of the location of the moving macro blocks.

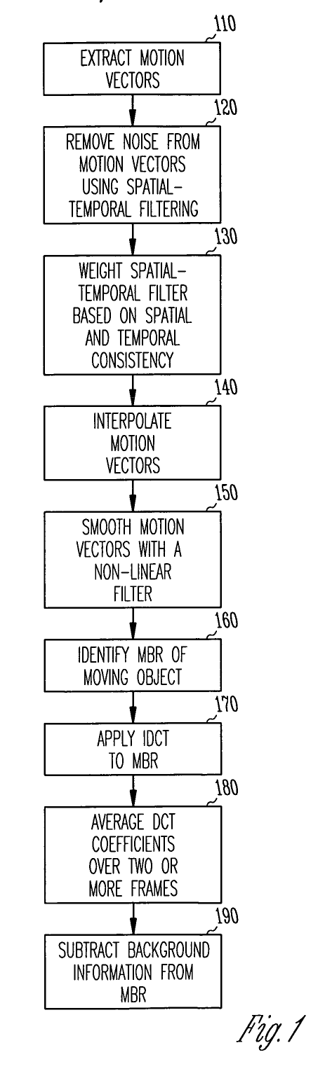

In most cases, the choice of the motion vector at the encoding (compression) end is motivated by the desire to get the highest compression efficiency. This then is one reason why the motion vectors contain a good deal of noise. The noise associated with motion vectors manifests itself primarily in two forms. First, spurious motion vectors are present in regions that are not really moving. Second, uniform (non-textured) regions of large moving objects often do not have any motion vectors assigned to them. Therefore, the task of removing noise from the motion vectors needs to be able to address both these aspects. In the prior art, the process of removing noise from a motion vector consists of applying spatial median filters. The spatial median filters are able to remove small spot noise in the image, but at the same time also remove genuine small movements in the scene. To counteract this, in an embodiment, the noise is removed from motion vectors by applying a simultaneous spatial-temporal filtering of the motion vectors. (FIG. 1, No. 120).

The spatial-temporal filter is defined as follows. At a frame t and macro block (i,j), V^{t}(i,j) is a vector consisting of the motion information in the (x,y) direction. A set SN={V^{t}(i,j),(i,j)εN(i,j)} is defined where N( [symbol] , [symbol] ) is an appropriate spatial neighborhood of i,j. Each vector v present in SN can be mapped to some blocks in the temporally adjacent frames. The motion vectors corresponding to these blocks in the temporally adjacent frames are represented by TN(v). TN(v) is a function of the current motion vector v under consideration. The spatial-temporally filtered motion vector at location (i,j), which is represented by F^{t}(i,j) is given as:

$${F}^{t} ( i , j ) = {argmin}_{ υ} {\sum }_{y ∈ SN} {( υ - y )}^{2} + {\sum }_{z ∈ TN ( υ )} {( υ - z )}^{2}$$

In an embodiment, the spatial consistency and temporal consistency are weighted equally. In another embodiment, where the number of elements in SN is larger than the number of elements in TN(v), the relative weight for the spatial consistency will be larger than that for the temporal consistency. A weighting factor is introduced to compensate for this. (FIG. 1, No. 130). For example, if the number of elements in SN is Ni and the number of elements in TN(v) is N2, the filter is now given as:

$${F}^{t} ( i , j ) = {argmin}_{ υ} {\sum }_{y ∈ SN} \frac{1}{N 1} {( υ - y )}^{2} + {\sum }_{z ∈ TN ( υ )} \frac{1}{N 2} {( υ - z )}^{2}$$

The idea of the spatial-temporal vector median filter is an extension of the basic vector median filter. Similar extensions of vector directional filters can also be used.

In an embodiment, as illustrated in FIG. 1, after the motion vectors are extracted (110) from a compressed video stream and the noise removed from the vectors (120), minimum bounded regions (MBR) of moving objects are identified (160). Subsequently, an Inverse Discrete Cosine Transform (IDCT) is applied locally to the identified MBRs and the corresponding region in the Intra (I) frame of the compressed data (170). Thereafter, an adaptive background subtraction operation is performed between IDCTed I and Predicted (P) frames to extract an object with its shape intact (190).

### Interpolation of the Motion Vectors

In addition to having unwanted noise associated with them, motion vectors, as noted supra, are normally available at macro block granularity while the DCT coefficients are normally available at block granularity. To address this inconsistency, in an embodiment, the motion vectors are interpolated in order to provide information at the block level (140). Then, once the motion vectors are interpolated, the resulting motion vector field is smoothed using a few iterations of a non-linear smoothing filter (150). In an embodiment, the smoothing factor between two adjacent blocks should ideally depend upon the histogram similarity between the two blocks. However, in some instances, only the DCT coefficients of the blocks are available. Therefore, as an approximation, the DC values (i.e. lower frequency) of the DCT coefficients are used as a measure of similarity to determine the smoothing factor between adjacent blocks. If a linear filtering were applied to the motion vectors, the object and a large part of its background would be identified as moving. However, due to the nonlinear nature of the smoothing filter, the moving regions can be identified without much of the background being identified.

### Combining DCT and Motion Vector Information

The AC, and AC₈ coefficients (i.e. high frequency) of the moving blocks are usually quite large. Therefore, in an embodiment, the motion blocks that are picked up are those for which both the final interpolated and smoothed motion vector is greater than a threshold value and (AC1+AC8)² is greater than a threshold.

### Identifying Sub-Block Movements

If an object is so small that its movement is within a single block, there usually are no motion vectors associated with the object. Consequently, such objects are not picked up using the above-described technique. However, if only the current DCT information is considered and the motion vectors are ignored, a lot of noisy macro blocks may also be picked up. To address this, in an embodiment, the DCT information (AC1+AC8)² of the current macro block is averaged over two or more temporally adjacent frames (180). If this average is larger than a preset threshold, then this macro block is considered as a moving macro block despite its not having a motion vector.

### Localized Spatial Processing

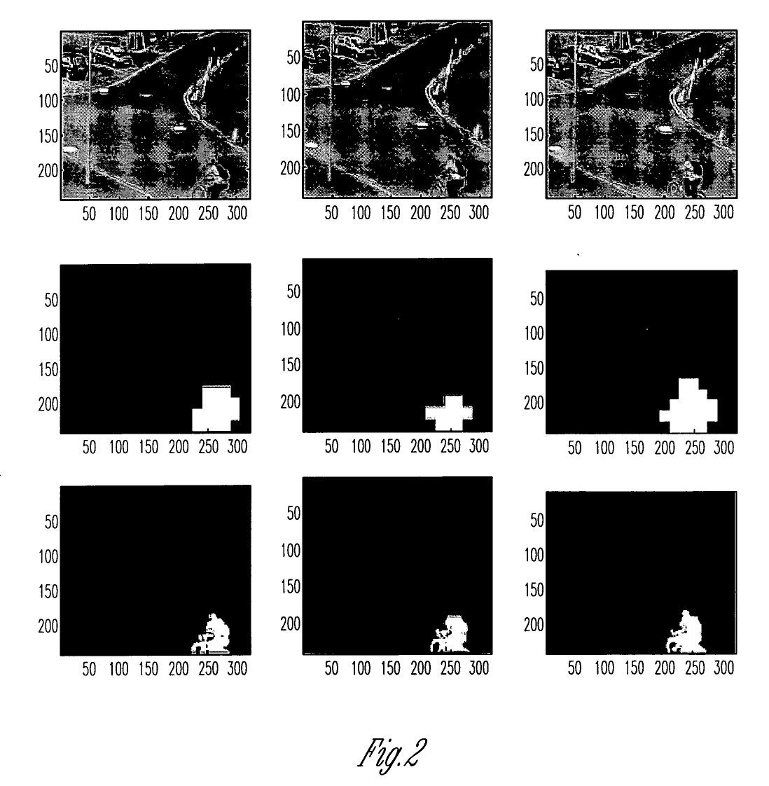

Due to the block based coding nature of compressed video data, identified motion regions (blobs) tend to encompass a significant portion of background region with it, leading to distorted measurement and localization information in addition to incorrect object boundary representation. Without consistency in these attributes, object tracking and classification become tedious tasks. In an embodiment, localized spatial processing is performed in the motion region (i.e. the MBRs of moving objects) that was identified by the motion vectors in the compressed data. For this purpose, inverse DCT (IDCT) is applied locally to those motion regions. With corresponding IDCT information from a reference I frame, a simple pixel-pixel differencing is computed, and the background information identified and subtracted out. FIG. 2 illustrates an example of the results obtained from this pixel-pixel differencing and background subtraction. The first row in FIG. 2 illustrates original frames of video data, the second row represents filtered motion blobs from MPEG, and the third row illustrates a motion blob after spatial processing. A preset threshold on this pixel-pixel difference helps in extracting a moving object with its shape and contour undistorted. The granularity of the motion region is also improved to pixel level granularity. This method assumes that there is no moving object in an I frame.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A process comprising:
extracting motion vectors from compressed video data;
identifying a minimum bounded region of a moving object within said compressed video data;
applying an inverse discrete cosine transform to said minimum bounded region; and
subtracting out background information from said minimum bounded region.

2. The process of claim 1, wherein said inverse discrete cosine transform is further applied to an Intra frame of said compressed data.

3. The process of claim 1, wherein said subtraction of said background information is performed between Intra and Predicted frames.

4. The process of claim 1, further comprising removing noise from said motion vectors.

5. The process of claim 4, wherein said noise is removed from said motion vectors by applying a simultaneous spatial-temporal filtering to said motion vectors.

6. The process of claim 5, wherein said simultaneous spatial-temporal filtered motion vector comprises:
$${F}^{t} ( i , j ) = {argmin}_{ υ} {\sum }_{y ∈ SN} {( υ - y )}^{2} + {\sum }_{z ∈ TN ( υ )} {( υ - z )}^{2}$$
wherein SN={V^{t}(i,j)};
V^{t} (i,j) is a vector comprising motion information in an (x,y) direction;
(i,j) is a macro block;
(i,j) is a member of N(i,j); and
N(i,j) is a spatial neighborhood of (i,j).

7. The process of claim 6, wherein said simultaneous spatial-temporal filtered motion vector is weighted based on a spatial consistency and a temporal consistency of said compressed data.

8. The process of claim 1, further comprising interpolating said motion vectors, thereby converting said motion vectors from a macro block granularity to a block granularity.

9. The process of claim 8, further comprising smoothing said motion vector using a non-linear smoothing filter.

10. The process of claim 1, further comprising averaging discrete cosine transform coefficients over two or more temporally adjacent frames, thereby identifying movement of an object within a block.

11. A machine readable medium including instructions thereon to cause a machine to execute a process comprising:
extracting motion vectors from compressed video data;
identifying a minimum bounded region of a moving object within said compressed video data;
applying an inverse discrete cosine transform to said minimum bounded region; and
subtracting out background information from said minimum bounded region.

12. The machine readable medium of claim 11,
wherein said inverse discrete cosine transform is further applied to an Intra frame of said compressed data; and further
wherein said subtraction of said background information is performed between Intra and Predicted frames.

13. The machine readable medium of claim 11, further comprising removing noise from said motion vectors.

14. The machine readable medium of claim 13, wherein said noise is removed from said motion vectors by applying a simultaneous spatial-temporal filtering to said motion vectors.

15. The machine readable medium of claim 14, wherein said simultaneous spatial-temporal filtered motion vector comprises:
$${F}^{t} ( i , j ) = {argmin}_{ υ} {\sum }_{y ∈ SN} {( υ - y )}^{2} + {\sum }_{z ∈ TN ( υ )} {( υ - z )}^{2}$$
wherein SN={V^{t}(i,j)};
V^{t}(i,j) is a vector comprising motion information in an (x,y) direction;
(i,j) is a macro block;
(i,j) is a member of N(i,j); and
N(i,j) is a spatial neighborhood of (i,j).

16. The machine readable medium of claim 15, wherein said simultaneous spatial-temporal filtered motion vector is weighted based on a spatial consistency and a temporal consistency of said compressed data.

17. The machine readable medium of claim 11, further comprising:
interpolating said motion vectors, thereby converting said motion vectors from a macro block granularity to a block granularity;
smoothing said motion vector using a non-linear smoothing filter; and
averaging discrete cosine transform coefficients over two or more temporally adjacent frames, thereby identifying movement of an object within a block.

18. A process comprising:
extracting motion vectors from compressed video data;
identifying a minimum bounded region of a moving object within said compressed video data;
applying an inverse discrete cosine transform to said minimum bounded region;
subtracting out background information from said minimum bounded region; and
removing noise from said motion vectors by applying a spatial-temporal filtering to said motion vectors.

19. The process of claim 18,
wherein said spatial-temporal filtered motion vector comprises:
$${F}^{t} ( i , j ) = {argmin }_{υ} {\sum }_{y ∈ SN} {( υ - y )}^{2} + {\sum }_{z ∈ TN ( υ )} {( υ - z )}^{2}$$
wherein SN={V^{t}(i,j)};
V^{t}(i,j) is a vector comprising motion information in an (x,y) direction;
(i,j) is a macro block;
(i,j) is a member of N(i,j); and
N(i,j) is a spatial neighborhood of (i,j).

20. The process of claim 18, wherein said spatial-temporal filtered motion vector is weighted based on a spatial consistency and a temporal consistency of said compressed data.
